(19) United States
(12) Patent Application Publication
(10) Pub. No.: US 2007/0062658 A1
(43) Pub. Date: Mar. 22, 2007

(54) Absorbent paper product having high definition embossments

(76) Inventors: Kevin Mitchell Wiwi, West Chester, OH (US); Donn Nathan Boatman, Union, KY (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/524,657

(22) Filed: Sep. 21, 2006

Related U.S. Application Data
(60) Provisional application No. 60/719,270, filed on Sep. 21, 2005.

(51) Int. Cl. B31F 1/07; B32B 3/00

(52) U.S. Cl. 162/117; 162/123; 428/156; 162/124

(57) ABSTRACT

The present invention provides for an embossed paper product comprising one or more plies of paper where at least one ply comprises a plurality of embossments where the embossments have an embossment height of from about 800 microns to about 2500 microns and an emboss impression angle of from about 90 degrees to about 150 degrees.

### CROSS-REFERENCE TO RELATED APPLICATION

This application claims the benefit of provisional application Ser. No. 60/719,270, filed Sep. 21, 2005.

### FIELD OF THE INVENTION

The present invention relates to absorbent paper products having new highly defined deep embossments.

### BACKGROUND OF THE INVENTION

The embossing of webs, such as paper webs, is well known in the art. Embossing of webs can provide improvements to the web such as increased bulk, improved water holding capacity, improved aesthetics and other benefits. Both single ply and multiple ply (or multi-ply) webs are known in the art and can be embossed. Multi-ply paper webs are webs that include at least two plies superimposed in face-to-face relationship to form a laminate.

During a typical embossing process, a web is fed through a nip formed between juxtaposed generally axially parallel rolls or cylinders. Embossing protrusions on one or both of the rolls compress and/or deform the web. If a multi-ply product is being formed, two or more plies are fed through the nip and regions of each ply are brought into a contacting relationship with the opposing ply. The embossed regions of the plies may produce an aesthetic pattern and provide a means for joining and maintaining the plies in face-to-face contacting relationship.

Embossing is typically performed by one of several processes; knob-to-rubber impression, knob-to-knob embossing or nested embossing. Knob-to-rubber impression embossing typically consists of two rolls, a hard embossing roll with emboss protrusions or knobs in a desired pattern and a back-side soft impression roll, often made up of a rubber. The rolls are aligned in an axially parallel configuration to form a nip between the rolls. As the paper web is passed through the nip between the rolls, the embossing knobs impress the web against and into the rubber to deform the structure of the web. Examples of knob-to-rubber impression are shown in U.S. Pat. No. 3,684,603 issued Nov. 9 to Iltis, 1967; U.S. Pat. No. 3,867,225 issued Feb. 18, 1975 to Nystrand; U.S. Pat. No. 4,927,588 issued May 22, 1990; U.S. Pat. No. 5,779,965 issued Jul. 14, 1998 to Beuther; and U.S. Pat. No. 6,755,928 B1 issued Jun. 29, 2004 to Biagiotti.

Knob-to-knob embossing typically consists of generally axially parallel rolls juxtaposed to form a nip within which the embossing protrusions, or knobs, on opposing rolls are aligned to press the web between the faces of the aligned protrusions. Knob-to-knob embossing generally produces a web comprising very compressed areas and surrounding pillowed regions which can enhance the thickness of the product. However, the pillows have a tendency to collapse under pressure due to lack of support. Consequently, the thickness benefit is typically lost during the balance of the converting operation and subsequent packaging, diminishing the quilted appearance and/or thickness benefit sought by the embossing.

Nested embossing typically consists of embossing protrusions of one roll meshed in between the embossing protrusions of the other roll. Examples of knob-to-knob embossing and nested embossing are illustrated in the prior art by U.S. Pat. No. 3,414,459 issued Dec. 3, 1968 to Wells; U.S. Pat. No. 3,547,723 issued Dec. 15, 1970 to Gresham; U.S. Pat. No. 3,556,907 issued Jan. 19, 1971 to Nystrand; U.S. Pat. No. 3,708,366 issued Jan. 2, 1973 to Donnelly; U.S. Pat. No. 3,738,905 issued Jun. 12, 1973 to Thomas; U.S. Pat. No. 3,867,225 issued Feb. 18, 1975 to Nystrand; U.S. Pat. No. 4,483,728 issued Nov. 20, 1984 to Bauernfeind; U.S. Pat. No. 5,468,323 issued Nov. 21, 1995 to McNeil; U.S. Pat. No. 6,086,715 issued Jun. 11, 2000 to McNeil; U.S. Pat. No. 6,277,466 Aug. 21, 2001; U.S. Pat. No. 6,395,133 issued May 28, 2002 and U.S. Pat. No. 6,846,172 B2 issued to Vaughn et al. on Jan. 25, 2005.

In some cases nested embossing may produce products exhibiting a softer, more quilted appearance that can be maintained throughout the balance of the converting process, including packaging. As the two plies travel through the nip of the embossing rolls, the patterns are meshed together. Nested embossing aligns the knob crests on the male embossing roll with the low areas on the female embossing roll. As a result, the embossed sites produced on one side of the structure provide support for the uncontacted side of the structure and the structure between embossment sites.

Another type of embossing, deep-nested embossing, has been developed and used to provide unique characteristics to the embossed web. Deep-nested embossing refers to embossing that utilizes paired emboss rolls, wherein the protrusions from the different emboss rolls are coordinated such that the protrusions of one roll fit into the spaces between the protrusions of the other emboss roll. Exemplary deep-nested embossing techniques are described in U.S. Pat. No. 5,686,168 issued to Laurent et al. on Nov. 11, 1997; U.S. Pat. No. 5,294,475 issued to McNeil on Mar. 15, 1994; U.S. patent application Ser. No. 11/059,986; U.S. patent application Ser. No. 10/700,131 and U.S. Patent Provisional Application Ser. No. 60/573,727.

While these deep-nested technologies have been useful in obtaining a deeper emboss pattern on paper substrates, it has been observed that when producing deep-nested embossed patterns on substrates that the resulting structure often is not strong enough that the structure may collapse when put under tension at a winding operation or within a package. This collapse in the emboss structure may result in inconsistent visual appearance and performance of the paper product.

Accordingly, it would be desirable to provide a deeply embossed paper product that has a sufficiently strong structure to better resist collapse from handling stresses and pressures.

### SUMMARY OF THE INVENTION

The present invention relates to an embossed paper product comprising one or more plies of paper where at least one ply comprises a plurality of embossments where the embossments have an embossment height of from about 800 microns to about 2500 microns and an emboss impression angle of from about 90 degrees to about 150 degrees.

### BRIEF DESCRIPTION OF THE DRAWINGS

FIG. 1 is a schematic side view of one embodiment of an apparatus that can be used to perform the deep-nested embossing of the present invention.

FIG. 2 is an enlarged side view of the nip formed between the embossing rolls of the apparatus shown in FIG. 1.

FIG. 3 is a schematic side view of one embodiment of an apparatus that can be used to perform the deep-nested embossing of the present invention.

FIG. 4 is a schematic side view of an alternative apparatus that can be used to perform the deep-nested embossing of the present invention.

FIG. 5 is a representative printout from the GFM MikroCAD optical profiler instrument used to measure the height, diameter, and impression angle of the embossments of the present invention.

FIG. 6 is an enlarged side view of the embossed roll shown in FIG. 2.

### DETAILED DESCRIPTION OF THE INVENTION

The present invention relates to an embossed paper product comprising one or more plies of paper where at least one ply comprises a plurality of embossments. In a particular embodiment, the embossments have an embossment height of greater than about 800 microns. In one embodiment, the embossments have an embossment height of from about 800 microns to about 2500 microns. In other embodiments, the embossments have an embossment height of from about 1000 microns to about 2000 microns. In other embodiments still, the embossments have an embossment height of from about 1250 microns to about 1750 microns. In some embodiments, the embossments have an emboss impression angle of less than 150 degrees. In one embodiment, the emboss impression angle is from about 90 degrees to about 150 degrees. In other embodiments, the emboss impression angle is from about 100 degrees to about 140 degrees. In yet another embodiment, the emboss impression angle is from about 105 degrees to about 135 degrees. In other embodiments still, the embossments have an emboss impression angle of from about 110 degrees to about 130 degrees. In a certain embodiment of the present invention the embossments have an emboss area of greater than about 7.5 mm². In another embodiment, the embossments have an emboss area of from about 7.5 mm² to about 15 mm². In other embodiments, the embossments have an emboss area of from about 8 mm² to about 14 mm². In other embodiments still, the embossments have an emboss area of from about 9 mm² to about 12 mm².

As used herein “paper product” refers to any formed, fibrous structure products, traditionally, but not necessarily comprising cellulose fibers. Certain embodiments of the paper products of the present invention include tissue-towel paper products.

A “tissue-towel paper product” refers to creped and/or uncreped products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

The term “ply” means an individual sheet of fibrous structure. In some embodiments, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the layers may or may not be homogenous within a layer. The actual makeup of a tissue paper ply is generally determined by the desired benefits of the final tissue-towel paper product, as would be known to one of skill in the art. The fibrous structure may comprise one or more plies of non-woven materials in addition to the wet-laid and/or air-laid plies.

The term “fibrous structure” as used herein means an arrangement of fibers produced in any papermaking machine known in the art to create a ply of paper. “Fiber” means an elongate particulate having an apparent length exceeding its apparent width. More specifically, and as used herein, fiber refers to such fibers suitable for a papermaking process. The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps, as well as mechanical pulps including, groundwood, thermomechanical pulp, chemically modified, and the like. Chemical pulps, however, may be preferred in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from wood pulp such as cotton linters, bagesse, and the like, can be used. Additionally, fibers derived from recycled paper, which may contain any of all of the categories as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, polyethylene, and polypropylene fibers can be used within the scope of the present invention. Further, such fibers may be latex bonded. Other materials are also intended to be within the scope of the present invention as long as they do not interfere or counter act any advantage presented by the instant invention.

In one embodiment, the present invention may incorporate the use of at least one or more plies of non-woven webs comprising synthetic fibers. Such exemplary substrates include textiles, other non-woven substrates, latex bonded web substrates, paper-like products comprising synthetic or multi-component fibers, and combinations thereof. Exemplary alternative substrates are disclosed in U.S. Pat. Nos. 4,609,518 and 4,629,643; and European Patent Application EP A 112 654.

A tissue-towel paper product substrate may comprise any tissue-towel paper product known in the industry and to those of skill in the art. Exemplary substrates are disclosed in U.S. Pat. Nos. 4,191,609; 4,300,981; 4,514,345; 4,528,239; 4,529,480; 4,637,859; 5,245,025; 5,275,700; 5,328,565; 5,334,289; 5,364,504; 5,411,636; 5,527,428; 5,556,509; 5,628,876; 5,629,052; and 5,637,194.

In one embodiment, tissue-towel product substrates may be through air dried or conventionally dried. In another embodiment, a preferred tissue-towel product substrate may be foreshortened by creping or wet micro-contraction. Exemplary creping and/or wet-micro contraction processes are disclosed in U.S. Pat. Nos. 4,191,756; 4,440,597; 5,865,950; 5,942,085; and 6,048,938.

Further, conventionally pressed tissue paper and methods for making such paper are known in the art. One embodiment comprises a pattern densified tissue paper that is characterized by having a relatively high bulk field of relatively low fiber density and an array of densified zones of relatively high fiber density. The high bulk field is alternatively characterized as a field of pillow regions. The densified zones are alternatively referred to as knuckle regions. The densified zones may be discretely spaced within the high bulk field or maybe interconnected, either fully or partially, within the high bulk field. Exemplary processes for producing pattern densified tissue webs are disclosed in U.S. Pat. Nos. 3,301,746; 3,473,576; 3,573,164; 3,821,068; 3,974,025; 4,191,609; 4,239,065; 4,528,239; and 4,637,859.

The first step in the practice of the papermaking process is directed toward providing an aqueous dispersion of papermaking fibers. Papermaking fibers useful in the present invention include those cellulosic fibers commonly known as wood pulp fibers. Fibers derived from soft woods (gymnosperms or coniferous tress) and hard woods (angiosperms or deciduous trees) are contemplated for use in the present invention. The particular species of tree from which the fibers are derived is immaterial.

The wood pulp fibers can be produced from the native wood by any convenience pulping process. Chemical processes such as sulfite, sulphate (including the Kraft) and soda processes are suitable. Mechanical processes such as thermomechanical (or Asplundh) processes are also suitable. In addition, the various semi-chemical and chemimechanical processes can be used. Bleached as well as unbleached fibers are contemplated for use with the present invention. In one embodiment, when the paper web of this invention is intended for use in absorbent paper products such as paper towels, bleached northern or southern softwood Kraft pulp fibers are preferred.

In addition to the various wood pulp fibers, other cellulosic fibers such as cotton linters, rayon, and bagasse can be used in the present invention. Synthetic fibers such as polyester and polyolefin fibers can also be used. Fibers also suitable for use with the present invention may include fibers, films and/or foams that comprise a hydroxyl polymer and optionally a crosslinking system. Nonlimiting examples of suitable hydroxyl polymers include polyols, such as polyvinyl alcohol, polyvinyl alcohol derivatives, polyvinyl alcohol copolymers, starch, starch derivatives, chitosan, chitosan derivatives, cellulose, cellulose derivatives such as cellulose ether and ester derivatives, gums, arabinans, galactans, proteins and various other polysaccharides, and mixtures thereof. For example, a web of the present invention may comprise a continuous and/or substantially continuous fiber comprising a starch hydroxyl polymer and a polyvinyl alcohol hydroxyl polymer produced by dry spinning and/or solvent spinning (both unlike wet spinning into a coagulating bath) a composition comprising the starch hydroxyl polymer and the polyvinyl alcohol hydroxyl polymer. Suitable fibers may also be coated or comprise latex, or latex-like, substances. Additional exemplary substrates are disclosed in U.S. Pat. Nos. 4,191,609; 4,300,981; 4,514,345; 4,528,239; 4,529,480; 4,637,859; 5,245,025; 5,275,700; 5,328,565; 5,334,289; 5,364,504; 5,411,636; 5,527,428; 5,556,509; 5,628,876; 5,629,052; and 5,637,194

Normally, the embryonic web is prepared from an aqueous dispersion of the papermaking fibers. However, one of skill in the art will realize that fluids other than water can be used to disperse the fibers prior to their formation into an embryonic web.

Any equipment commonly used in the art for dispersing fibers can be used. The fibers are normally dispersed at a consistency of from about 0.1% to about 0.3% at the time an embryonic web is formed. As used herein, the moisture content of various dispersions, webs, and the like, is expressed in terms of percent consistency. Percent consistency is defined as 100 times the quotient obtained when the weight of dry fiber in the system under discussion is divided by the total weight of the system. An alternate method of expressing moisture content of a system sometimes used in the papermaking art is pounds of water per pound of fiber or alternatively and equivalently, kilograms of water per kilogram of fiber. The correlation between the two methods of expressing moisture content can be readily developed. For example, a web having a consistency of 25% comprises 3 kilograms of water per kilogram of fiber. A web having a consistency of 50% comprises 1 kilogram of water per kilogram of fiber. A web having a consistency of 75% comprises 0.33 kilograms of water per kilogram of fiber. Fiber weight is typically expressed on the basis of bone dry fibers.

The next step of the papermaking process provides for the formation of an embryonic web of papermaking fibers on a first foraminous member from the aqueous dispersion provided in the first step. As used herein, an embryonic web is that web of fibers which is subjected to rearrangement on the deflection member hereinafter described. The embryonic web is typically formed from the aqueous dispersion of papermaking fibers by depositing that dispersion onto a foraminous surface and removing a portion of the aqueous dispersion medium. The fibers in the embryonic web normally have a relatively large quantity of water associated with them, typically ranging from about 5% to about 25%. As such, an embryonic web is typically too weak to be capable of existing without the support of an extraneous element such as a Fourdrinier wire. Regardless of the technique by which an embryonic web is formed, at the time of formation, such a web is subjected to rearrangement on the deflection member. Thus, the web must be held together by bonds weak enough to permit rearrangement of the fibers under the action of the forces required.

Any of the numerous techniques known to those of skill in the papermaking art can be used to provide for a suitable embryonic web. The precise method by which the embryonic web is formed is immaterial to the practice of the present invention so long as the embryonic web possesses the characteristics required. As a practical matter, continuous papermaking processes are used in one embodiment, even though batch processes, such as hand-sheet making processes, can be used. Processes that lend themselves to the practice of this step are described in U.S. Pat. Nos. 3,301,746; and 3,994,771.

As would be known to those of skill in the art, an aqueous dispersion of papermaking fibers is prepared and provided to a headbox that can be of any convenient design. From the headbox, an aqueous dispersion of papermaking fibers is delivered to a first foraminous member, typically a Fourdrinier wire.

The first foraminous member is typically supported by a breast roll and a plurality of return rolls. Optional auxiliary units and devices commonly associated with papermaking machines and with a first foraminous member may include forming boards, hydrofoils, vacuum boxes, tension rolls, support rolls, wire cleaning showers, and the like. In any regard, the purpose of a headbox and first foraminous member and any of the aforementioned auxiliary units and devices is to form an embryonic web of papermaking fibers.

After the aqueous dispersion of papermaking fibers is deposited onto a first foraminous member, the embryonic web is formed by removal of a portion of the aqueous dispersing medium by techniques well known to those of skill in the art. In this regard, vacuum boxes, forming boards, hydrofoils, and the like, may be useful in effecting water removal from the aqueous dispersion. Typically, an embryonic web travels with the first foraminous member about a return roll and is brought into the proximity of a second foraminous member.

The third step in the papermaking process provides associates the embryonic web with a second foraminous member. This second foraminous member is sometimes referred to as a “deflection member.” This third step provides the embryonic web into engaging contact with the deflection member on which the embryonic web will be deflected, rearranged, and further dewatered.

A deflection member suitable for use with the present invention takes the form of an endless belt. Typically, a deflection member passes around, and about, deflection member return rolls and impression nip rolls. Support rolls, return rolls, cleaning means, drive means, and the like, commonly used in papermaking processes and machines thereof, can also be associated with the deflection member. However, whatever physical form the deflection member takes (i.e., an endless belt, a stationary plate, or rotating drum and the like), the deflection member may be foraminous in certain embodiments. In other words, the deflection member must possess continuous passages connecting a first surface (also known in the art as the “upper surface” or “working surface” or the “embryonic web-contacting surface”) with its second surface (also known as the “lower surface”). Stated in another way, the deflection member must be constructed in such a manner that when water is caused to be removed from the embryonic web, such as by the application of differential fluid pressure, that when the water is removed from the embryonic web in the direction of the foraminous member, the water can be discharged from the system without having to again contact the embryonic web in either the liquid or the vapor state.

Secondly, in one embodiment, the embryonic web-contacting surface of the deflection member comprises a macroscopically mono-planer, patterned, continuous network surface. This network surface may define within the deflection member, a plurality of discrete, isolated, deflection conduits. When a portion of the embryonic web-contacting surface of the deflection member is placed into a planer configuration, the network surface is essentially mono-planer. It is said to be “essentially” mono-planer to recognize the fact that deviations from absolute planarity are tolerable, but not preferred, so long as the deviations are not substantial enough to adversely affect the performance of the product formed on the deflection member. The network surface is said to be “continuous” because the lines formed by the network surface must form at least one essentially unbroken net-like pattern. The pattern is said to “essentially” continuous to recognize the fact that interruptions in the pattern are tolerable, but not preferred, so long as the interruptions are not substantial enough to adversely affect the performance of the product made on the deflection member. It should be understood that a network surface can be provided with a variety of patterns having various shapes, sizes, and orientations, as well as the deflection conduits provided within a deflection member. In one embodiment, a deflection member is foraminous in that deflection conduits provided therein extend through the entire thickness of a deflection member and provide the necessary continuous passages connecting its two surfaces.

As will be known to one of skill in the art, the deflection conduits provided may be discrete. In other words, the deflection conduits can have a finite shape that depends on the pattern selected for the network surface and are separated one from another. However, an infinite variety of geometries for the network surface and the openings of the deflection conduits are possible. However, it should be recognized that since the network surface defines the deflection conduits, the specification of the relative directions, orientations, and widths of each element or branch of the network surface will, of necessity, define the geometry and distribution of the openings of the deflection conduits. Conversely, specification of the geometry and distribution of the openings of the deflection conduits will define the relative directions, orientations, widths, and the like, of each branch of the network surface. Further, while the openings of the deflection conduit can be a random shape and in random distribution, they are preferably of a uniform shape and are distributed in a repeating, pre-selected pattern. Practical shapes include circles, ovals, and polygons of six or fewer sides. However, there is no requirement that the openings of the deflection conduits be regular polygons or that the sides of the openings be straight. Openings with curved sides, such as trilobal figures may be used.

In one embodiment, the deflection member is an endless belt which can be constructed by a method adapted from techniques used to make stencil screens. By adapted, it is meant that the broad, overall techniques of making stencil screens are used, however, improvements, refinements, and modifications, may be used to make the member having significantly greater thickness than the usual stencil screen.

In one embodiment, a foraminous element is thoroughly coated with a liquid photosensitive polymeric resin to a pre-selected thickness. A mask, or negative, incorporating the pattern of the pre-selected network surface is juxtaposed the liquid photosensitive resin. The resin is then exposed to light of an appropriate wavelength through the mask. This exposure to light causes the resin to cure in the exposed areas. Unexposed, and uncured, resin is thereafter removed from the system leaving behind the cured resin forming the network surface defining within it, a plurality of discrete, isolated deflection conduits. Additionally, the deflection member can be prepared using as the foraminous woven element, a belt of width and length suitable for use on the chosen papermaking machine. The network surface and the deflection conduits are formed on this woven belt in a series of sections of convenient dimensions in a batch-wise manner. The preparation of an exemplary deflection member is discussed in detail in U.S. Pat. No. 4,529,480.

The fourth step of the papermaking process requires deflecting the fibers in the embryonic web into the deflection conduits and removing water from the embryonic web such as by the application of differential fluid pressure to the embryonic web thereby forming an intermediate web of papermaking fibers. Such deflection is to be effected under such conditions that there is essentially no water removal from the embryonic web through the deflection conduits after the embryonic web has been associated with the deflection member prior to the deflecting of the fibers into the deflection conduits. Such deflection can be induced by the application of differential fluid pressure to the embryonic web. In one embodiment, the method of applying differential fluid pressure is by exposing the embryonic web to a vacuum in such a way that the web is exposed to the vacuum through a deflection conduit by application of a vacuum to the deflection member on the side designated to be a bottom surface. Such vacuum can be provided by the use of a vacuum box. Optionally, positive pressure in the form of air or steam pressure can be applied to an embryonic web in the vicinity of the vacuum box through the first foraminous member. In this step, an embryonic web has then been transformed into an intermediate web.

The fifth step in the papermaking process is the drying of the intermediate web to form a paper web of the present invention. As should be known to those of skill in the art, any convenient means can be used to dry the intermediate web. For example, flow-through dryers and Yankee Dryers, alone and in combination, are satisfactory.

In one embodiment, the quantity of water removed in a pre-dryer is controlled so that a pre-dried web exiting such a pre-dryer has a consistency of from about 30% to about 98%. The pre-dried web, which is still associated with the deflection member, passes around the deflection member return roll and may travel to an impression nip roll. As the pre-dried web is preferably passed through a nip formed between an impression nip roll and a Yankee Dryer drum, the network pattern formed by the deflection member is impressed into the pre-dried web to form an imprinted web. In one embodiment, this imprinted web is adhered to the surface of a Yankee Dryer drum, where it is dried to a consistency of at least about 95%.

An optional sixth step provides for foreshortening of the dried web. Foreshortening refers to the reduction in length of a dry paper web that occurs when energy is applied to the dry web in such a way that the length of the web is reduced and the fibers in the web are rearranged with an accompanying disruption of fiber-fiber bonds. Foreshortening can be accomplished in any of several well-known ways. The most common method of foreshortening is creping. In such a creping operation, the dried web is adhered to the surface and then removed from that surface with a doctor blade. Usually, the surface to which the web is adhered also functions as a drying surface and can be the surface of a Yankee Dryer or any other drying surface present in the drying operation.

As mentioned, supra, the pre-dried web typically passes through the nip formed between an impression nip and the Yankee Dryer drum. At this point, the network pattern formed by the deflection member is impressed into the pre-dried web to form the imprinted web. This imprinted web is adhered to the surface of the Yankee Dryer drum. Such adherence is facilitated by the use of a creping adhesive. Typical creping adhesives include those based on polyvinyl alcohol. Examples of adhesives suitable for use with the present invention are described in U.S. Pat. No. 3,926,716. The adhesive is applied to either the pre-dried web immediately prior to its passage through the nip or the surface of the Yankee Dryer drum prior to the point at which the web is pressed against the surface thereto. The paper web adhered to the surface of the Yankee is dried to at least about 95% consistency and is removed (i.e., creped) from that surface by the doctor blade. Energy is thus supplied to the web and the web is foreshortened. The exact pattern of the network surface and its orientation relative to the doctor blade will, in major part, dictate the extent and the character of the creping imparted to the web.

The paper web, can then be calendared and rewound, or cut and stacked, as required. This paper web is then ready for use.

An exemplary process for embossing a web substrate in accordance with the present invention incorporates the use of a knob-to-rubber impression embossment technology. By way of a non-limiting example, a tissue ply structure is embossed in a gap between an embossing roll and a backside impression roll. The embossing roll may be made from any material known for making such rolls, including, without limitation, steel, ebonite, hard rubber and elastomeric materials, and combinations thereof. The backside impression roll may be made from any material for making such rolls, including, without limitation soft rubber. As known to those of skill in the art, the embossing roll may be provided with a combination of emboss protrusions and gaps. Each emboss protrusion comprises a base, a face, and one or more sidewalls. Each emboss protrusion also has a height, h. The height of the emboss protrusions may range from about 1.8 mm (0.070 in.) to about 3.8 mm (0.150 in.). In another embodiment, the emboss protrusions have a height of from about 2.0 mm (0.080 in.) to about 3.3 mm (0.130 in.).

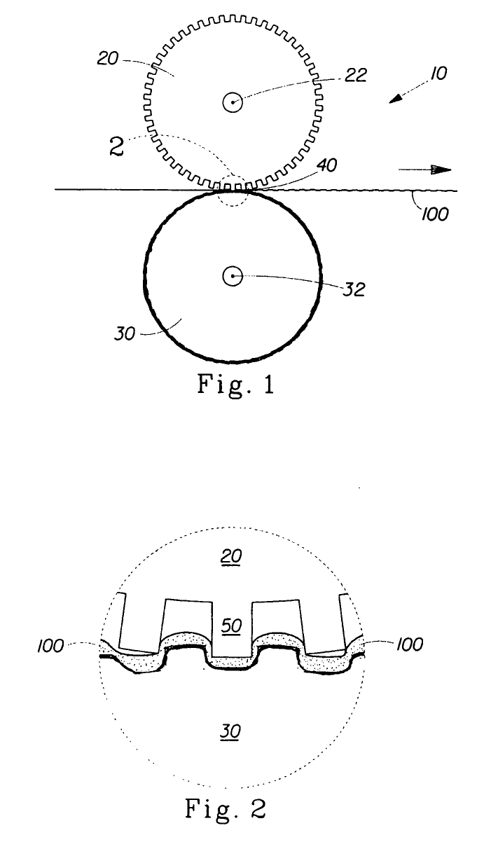

FIG. 1 shows one embodiment of an embossing apparatus 10 for making the present invention. The apparatus 10 includes a pair of rolls, an embossing roll 20 and a backside impression roll 30. (It should be noted that the embodiments shown in the figures are just exemplary embodiments and other embodiments are certainly contemplated. For example, the embossing roll 20 of the embodiment shown in FIG. 1 could be replaced with any other embossing members such as, for example, plates, cylinders or other equipment suitable for embossing webs. Further, additional equipment and steps that are not specifically described herein may be added to the apparatus and/or process of the present invention.) The embossing roll 20 and the backside impression roll 30 are disposed adjacent each other to provide a nip 40. The rolls 20 and 30 are generally configured so as to be rotatable on an axis, the axes 22 and 32, respectively, of the rolls 20 and 30 are typically generally parallel to one another. The apparatus 10 may be contained within a typical embossing device housing. The embossing roll 20 has an outer surface comprising a plurality of embossing protrusions 50 (shown in more detail in FIG. 2) generally arranged in a non-random pattern. As shown in FIG. 1, the rolls 20 and 30 provide a nip 40 through which a web 100 can pass. In the embodiment shown, the web 100 is made up of a single ply.

The pressure of the emboss roll 20 against the backside impression roll 30 pushes the ply or plies against the impression roll. This can be observed in that the softer backside impression roll 30 is pushed in upon contact. The length of the nip or “nip length” of the embossing process is defined as the linear circumferential distance along the arc that the two rolls are in contact. The nip length may be used to quantify the emboss pressure applied to the paper structure.

FIG. 2 is an enlarged view of the portion of the apparatus 10 labeled 2 in FIG. 1. The figure shows a more detailed view of the web 100 passing through the nip 40 between the embossing roll 20 and the backside impression roll 30. As can be seen in FIG. 2, the first embossing roll 20 includes a plurality of first embossing protrusions 50 extending from the surface of the first embossing roll 20. The surface of the backside embossing roll 30 is shown being deflected at the pressure applied by the protrusion knobs. (It should be noted that when the embossing protrusions 50 are described as extending from a surface of an embossing roll, the embossing protrusions may be integral with the surface of the embossing member or may be separate protrusions that are joined to the surface of the embossing member.) As the ply of the web 100 is passed through the nip 40, it is macroscopically deformed by the pressure applied by the protrusions from the protrusions 50 of the emboss roll 20 and the resistance force of the softer backside impression roll 30.

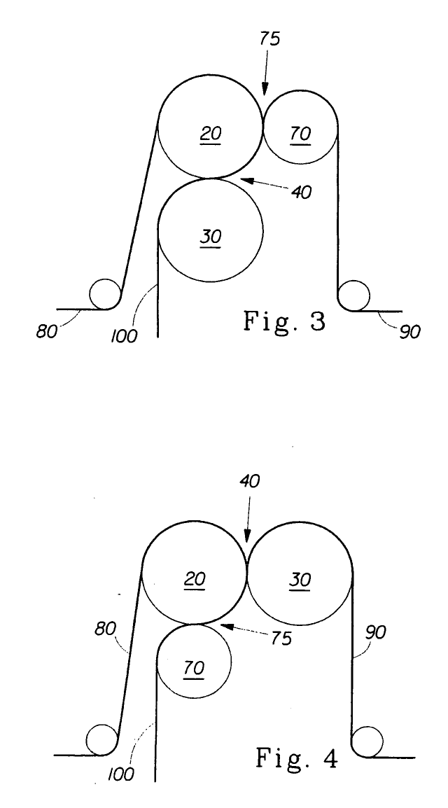

While the apparatus shown in FIG. 1 may be used for webs having one ply, the apparatus may be used to make multi-ply products as well. FIG. 3 shows an embodiment of the process of the present invention where a two ply product is produced where both plies are embossed. The first ply 80 and the second ply 90 of resulting web 100 are first joined together between marrying roll 70 and the embossing roll 20. The plies 80 and 90 can be joined together by any known means, but typically an adhesive application system is used to apply adhesive to one or both of the plies 80 and 90 prior to the plies being passed between the first nip 75 formed between the marrying roll 70 and the embossing roll 20. The combined web 100 is then passed through the second nip 40 formed between the embossing roll 20 and the backside impression roll 30 where it is embossed.

In another embodiment of the present invention to produce multi-ply products, as shown in FIG. 4, the plies 80 and 90 are passed through the second nip 40 formed between the embossing roll 20 and the backside impression roll 30 where the plies are placed into contact with each other and embossed. At this stage, it is also common to join the webs together using conventional joining methods such as an adhesive application system, but, as noted above, other joining methods can be used. The combined web 100 is then passed through the first nip 75 between the embossing roll 20 and the marrying roll 70. This step is often used to ensure that the plies 80 and 90 of the web 100 are securely joined together before the web 100 is directed to further processing steps or winding.

It should be noted that with respect to any of the methods described herein, the number of plies is not critical and can be varied, as desired. Thus, it is within the realm of the present invention to utilize methods and equipment that provide a final web product having a single ply, two plies, three plies, four plies or any other number of plies suitable for the desired end use. In each case, it is understood that one of skill in the art would know to add or remove the equipment necessary to provide and/or combine the different number of plies. Further, it should be noted that the plies of a multi-ply web product need not be the same in make-up or other characteristics. Thus, the different plies can be made from different materials, such as from different fibers, different combinations of fibers, natural and synthetic fibers or any other combination of materials making up the base plies. Further, the resulting web 100 may include one or more plies of a cellulosic web and/or one or more plies of a web made from non-cellulose materials including polymeric materials, starch based materials and any other natural or synthetic materials suitable for forming fibrous webs. In addition, one or more of the plies may include a nonwoven web, a woven web, a scrim, a film a foil or any other generally planar sheet-like material. Further, for webs with two or more plies, one or more of the plies can be embossed with a pattern that is different than one or more of the other plies or can have no embossments at all.

As would be known to one of skill in the art, the plurality of embossments of the embossed tissue paper product of the present invention could be configured in a non-random pattern. Further, such embossments may be embodied in random patterns as well as combinations of random and non-random patterns.

The embossed paper product of the present invention may comprise one or more plies of tissue paper. In one embodiment, the embossed paper product comprises two or more plies. In another embodiment, at least one of the plies comprises a plurality of embossments. When the embossed paper product comprises two or more plies of tissue structure, the plies may be the same substrate respectively, or the plies may comprise different substrates combined to create any desired consumer benefit(s). Some embodiments of the present invention comprise two plies of tissue substrate. Another embodiment of the present invention comprises a first outer ply, a second outer ply, and at least one inner ply.

The process of the present invention may also comprise the step of conditioning the one or more plies of paper. The conditioning step comprises heating the one or more plies of paper, adding moisture to the one or more plies of paper, or both heating and adding moisture to the one or more plies of paper. Examples of such conditioning steps are illustrated in co-pending published U.S. patent application Ser. Nos. 2006/021,480 and 2006/022,397.

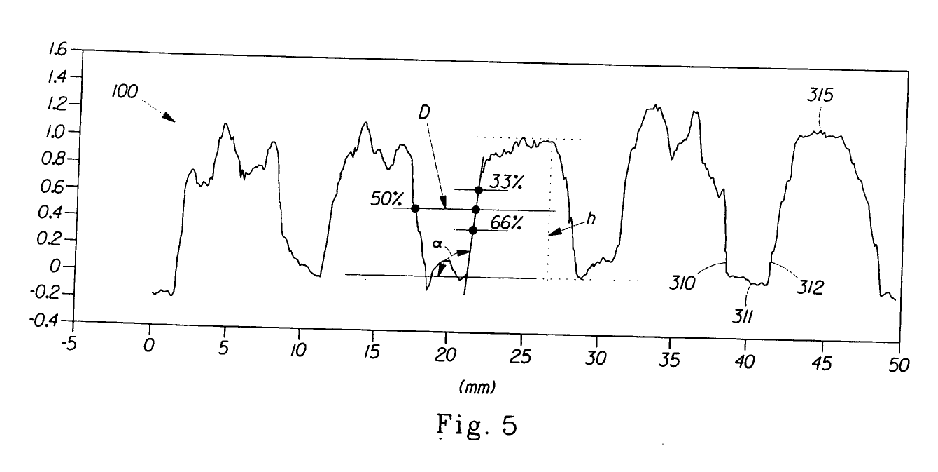

FIG. 5 shows a cross-sectional view of one embodiment of the embossed paper product of the present invention. The embossed web product 100 comprises one or more plies, wherein at least one of the plies comprises a plurality of embossments 310. The embossments are deformations in the base fibrous structure having a top surface 315. Each embossment may be characterized as having a bottom wall 311 and a side wall 312.

The embossed paper product of the present invention comprises one or more plies of paper. At least one of the plies is embossed so it comprises a plurality of embossments. In one embodiment, the embossments of the product of the present invention have an embossment height, h, of greater than about 800 microns. In another embodiment, the embossments have an embossment height of from about 800 microns to about 2500 microns. In other embodiments, the embossments have an embossment height of from about 1000 microns to about 2000 microns. In other embodiments still, the embossments have an embossment height of from about 1250 microns to about 1750 microns. The embossment height, h, is measured using the Embossment Structure Measurement Method described in the test methods section herein. Referring to FIG. 5, the embossment height, h, is a measure from the top of the unembossed structure to the bottom of the embossment as described in the test methods section.

In an embodiment, the embossments have an emboss impression angle of less than about 150 degrees. In another embodiment, the embossments have an emboss impression angle of from about 90 degrees to about 150 degrees. In other embodiments, the emboss impression angle is from about 100 degrees to about 140 degrees. In yet another embodiment, the emboss impression angle is from about 105 degrees to about 135 degrees. In other embodiments still, the embossments have an emboss impression angle of from about 110 degrees to about 130 degrees. The emboss impression angle is measured using the Embossment Structure Measurement described herein.

The emboss impression of the product of the present invention is accentuated when the embossments have a relatively large emboss area. In certain embodiments of the present invention the embossments have an emboss area of greater than about 7.5 mm². In another embodiment, the embossments have an emboss area of from about 7.5 mm² to about 15 mm². In other embodiments, the embossments have an emboss area of from about 8 mm² to about 14 mm². In other embodiments still, the embossments have an emboss area of from about 9 mm² to about 12 mm². The emboss area is measured using the Embossment Structure Measurement Method described herein.

Selected embodiments of the present invention will have a total embossed area of from about 1% to about 20%. In other embodiments, the total embossed area is from about 2% to about 15%. In other embodiments still, the total embossed area is from about 3% to about 10%. In yet other embodiments, the total embossed area is from about 4% to about 8%. Embossed area, as used herein, means the area of the paper structure that is directly contacted and compressed by either positive or negative embossing protrusions. Portions of the paper substrate that are deflected as a result of engagement between positive and negative embossment knobs are not considered part of the embossed area.

The embossed product of the present invention may comprise only one ply of such embossed substrates. Such an exemplary process can facilitate the combination of one ply that is embossed and other non-embossed plies. Alternatively, at least two plies can be combined and then embossed together in such an embossing process. An exemplary embodiment of the latter combination provides an embossed tissue-towel paper comprising more than one ply where the first and second outer plies are embossed and the resulting embossed plies are subsequently combined with one or more additional plies of the tissue substrate.

Optional Ingredients

As would be known to one of skill in the art, surfactants may be used to treat tissue paper embodiments of the webs if enhanced absorbency is required. In one embodiment, surfactants can be used at a level ranging from about 0.01% to about 2.0% by weight based on the dry fiber weight of the tissue web. In one embodiment surfactants have alkyl chains having at least 8 carbon atoms. Exemplary anionic surfactants include, but are not limited to, linear alkyl sulfonates and alkylbenzene sulfonates. Exemplary, but non-limiting non-ionic surfactants include alkylglycosides, esters therefrom, and alkylpolyethoxylated esters. Further, as would be known to one of skill in the art, cationic softener active ingredients with a high degree of unsaturated (mono and/or poly) and/or branched chain alkyl groups can enhance absorbency.

It is also intended that other chemical softening agents may be used in accordance with the present invention. In one embodiment, chemical softening agents may comprise quaternary ammonium compounds such as dialkyldimethylammonium salts, mono- or di-ester variations therefrom, and organo-reactive polydimethyl siloxane ingredients such as amino functional polydimethyl siloxane.

In addition to papermaking fibers, certain embodiments may comprise an embryonic web that is formed from a dispersion that may include various additives commonly used in the papermaking process. Examples of useful additives include wet strength agents such as urea-formaldehyde resins, melamine-formaldehyde resins, polyamide-epichlorohydrin resins, polyethyleneimine resins, polyacrylamide resins, and dialdehyde starches. Dry-strength additives, such as polysalt-coacervates rendered water-soluble by the inclusion of ionization suppressers, can also be used as would be known by one of skill in the art.

Other useful additives include debonders that increase the softness of the paper webs. Specific debonders that can be used in the present invention include quaternary ammonium chlorides. Exemplary debonders are described in U.S. Pat. Nos. 3,554,863; 4,144,122; and 4,351,669. Further, pigments, dies, fluorescers, and the like, commonly used in paper products can be incorporated into the dispersion.

Embossing Roll Protrusions

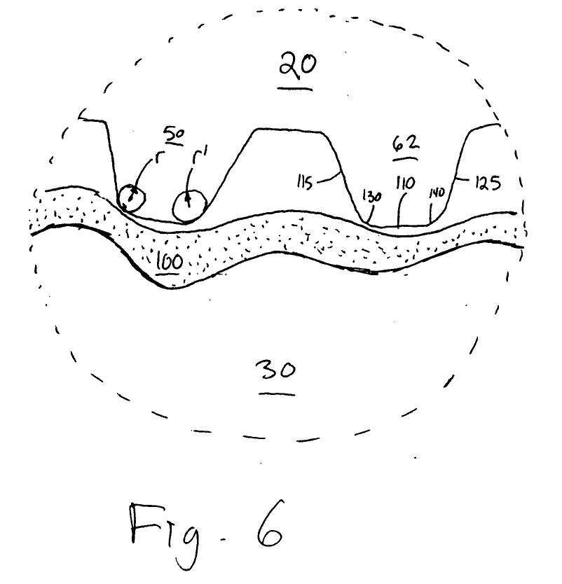

In one embodiment of the present invention, shown in FIG. 6, the embossing protrusions 50 of the emboss roll 20, whether linear or discrete, may have a leading transition region 130 between the distal end 110 of the embossing protrusion 50 and the leading sidewall 115 of the embossing protrusion 50 that has a leading transition region radius of curvature r. In another embodiment of the present invention, the embossing protrusions 50 of the emboss roll 20, whether linear or discrete, may have a trailing transition region 140 between the distal end 110 of the embossing protrusion 50 and the trailing sidewall 125 of the embossing protrusion 50 that has a trailing transition region radius of curvature r'. The leading transition region 130 engages the web 100 before the trailing transition region 140. The backside impression roll 30 shown in FIG. 6 is identical to the backside impression roll 30 shown in FIG. 3.

In an embodiment, the radii of curvature for the leading transition region r or the trailing transition region r' is from about 0.075 mm to about 1.8 mm. In a different embodiment, the radii of curvature for the leading transition region r or the trailing transition region r' is from about 0.1 mm to about 1.5 mm. In a different embodiment still, the radii of curvature for the leading transition region r or the trailing transition region r' is from about 0.5 mm to about 1.0 mm. The radii of curvature for the leading transition region r or the trailing transition region r' can be any number within the aforementioned embodiments, and any combination of the aforementioned radii to create a range.

In one embodiment, the “rounding” of the leading transition region 130 or trailing transition region 140 typically results in a circular arc rounded leading transition region 130 or trailing transition region 140 from which a radius of curvature is determined as the radius of curvature of the arc. Another embodiment also contemplates transition region configurations which approximate an arc rounding by having the edge of the leading transition region 130 or trailing transition region 140 removed by one or more straight line or irregular cut lines. In such cases, the leading transition radius of curvature r or trailing transition radius of curvature r' is determined by measuring the radius of curvature of a circular arc that includes a portion which approximates the curve of the leading transition region 130 or trailing transition region 140, respectively. In one embodiment, r is the same as r'. In another embodiment, r is greater than r'. In another embodiment still, r is less than r'.

In one embodiment, at least a portion of the distal end 110 of one or more of the embossing protrusions 50 other than the leading transition regions 130 or trailing transition regions 140 can be planar or non-planar. In some embodiments, the distal end 110 is curved or rounded. Thus, the entire surface of the embossing element spanning between the leading sidewalls 115 and trailing sidewalls 125 can be non-planar, for example curved or rounded. The non-planar surface can take on any shape, including, but not limited to smooth curves or curves, as described above, that are actually a number of straight line or irregular cuts to provide the non-planar surface. One example of such an embossing element is the embossing element 62 shown in FIG. 6. Although not wishing to be bound by theory, it is believed that rounding the leading transition regions 130 or trailing transition regions 140 or any portion of the distal ends of the embossing protrusions can provide the resulting paper with embossments that are more blunt with fewer rough edges. Thus, the resulting paper may be provided with a smoother and/or softer look and feel. An example of an emboss roll that can be nested with another emboss roll with similar emboss roll protrusions is disclosed in pending U.S. patent application Ser. No. 11/222,701.

### EXAMPLES

### Example 1

One fibrous structure useful in achieving the embossed paper product of the present invention is the through-air-dried (TAD), differential density structure described in U.S. Pat. No. 4,528,239. Such a structure may be formed by the following process.

A Fourdrinier, through-air-dried papermaking machine is used in the practice of this invention. A slurry of papermaking fibers is pumped to the headbox at a consistency of about 0.15%. The slurry consists of about 55% Northern Softwood Kraft fibers, about 30% unrefined Eucalyptus fibers and about 15% repulped product broke. The fiber slurry contains a cationic polyamine-epichlorohydrin wet burst strength resin at a concentration of about 10.0 kg per metric ton of dry fiber, and carboxymethyl cellulose at a concentration of about 3.5 kg per metric ton of dry fiber.

Dewatering occurs through the Fourdrinier wire and is assisted by vacuum boxes. The wire is of a configuration having 41.7 machine direction and 42.5 cross direction filaments per cm, such as that available from Asten Johnson known as a “786 wire”.

The embryonic wet web is transferred from the Fourdrinier wire at a fiber consistency of about 22% at the point of transfer, to a TAD carrier fabric. The wire speed is about 660 meters per minute. The carrier fabric speed is about 635 meters per minute. Since the wire speed is about 4% faster than the carrier fabric, wet shortening of the web occurs at the transfer point. Thus, the wet web foreshortening is about 4%. The sheet side of the carrier fabric consists of a continuous, patterned network of photopolymer resin, the pattern containing about 90 deflection conduits per inch. The deflection conduits are arranged in an amorphous configuration, and the polymer network covers about 25% of the surface area of the carrier fabric. The polymer resin is supported by and attached to a woven support member having of 27.6 machine direction and 11.8 cross direction filaments per cm. The photopolymer network rises about 0.43 mm above the support member.

The consistency of the web is about 65% after the action of the TAD dryers operating about a 254° C., before transfer onto the Yankee dryer. An aqueous solution of creping adhesive consisting of animal glue and polyvinyl alcohol is applied to the Yankee surface by spray applicators at a rate of about 0.66 kg per metric ton of production. The Yankee dryer is operated at a speed of about 635 meters per minute. The fiber consistency is increased to an estimated 95.5% before creping the web with a doctor blade. The doctor blade has a bevel angle of about 33 degrees and is positioned with respect to the Yankee dryer to provide an impact angle of about 87 degrees. The Yankee dryer is operated at about 157° C., and Yankee hoods are operated at about 120° C.

The dry, creped web is passed between two calendar rolls and rolled on a reel operated at 606 meters per minute so that there is about 9% foreshortening of the web by crepe; about 4% wet microcontraction and an additional 5% dry crepe.

The paper described above is then subjected to a knob-to-rubber impression embossing process follows. An emboss roll is engraved with a nonrandom pattern of protrusions. The emboss roll is mounted, along with a backside impression roll, in an apparatus with their respective axes being generally parallel to one another. The emboss roll comprises embossing protrusions which are frustaconical in shape, with a face (top or distal—i.e. away from the roll from which they protrude) diameter of about 2.79 mm and a floor (bottom or proximal—i.e. closest to the surface of the roll from which they protrude) diameter of about 4.12 mm. The height of the embossing protrusions on the emboss roll is about 2.845 mm. The radius of curvature of the transition region of the embossing protrusions is about 0.76 mm. The planar projected area of each embossing single pattern unit is about 25 cm². The nonrandom pattern of emboss protrusions comprises approximately 10% emboss contact area. The backside impression roll is made of Valcoat™ material from Valley Roller Company, Mansfield, Tex. and has a P&J softness value of 125. The impression roll is set to deliver a nip length of about 2 inches (5 cm) by applying a pressure of approximately 140 pounds per linear inch (pli) of roller. The 140 pli applied to a 2 inch nip width on an emboss pattern with 10% contact area results in a pressure at the emboss knobs of from about 600 pounds per square inch to about 800 pounds per square inch of emboss contact area. The paper web is passed through the nip at a speed of 1000 feet per minute.

The resulting paper has an embossment height of greater than 800 μm, an embossment area of greater than 7.5 mm² and an embossment impression angle of less than 150°.

### Example 2

In another embodiment of the embossed paper products of the present invention, the embossing process of Example 1 is modified such that the paper of Example 1 is conditioned with steam before it is delivered to the embossing cylinders. The resulting paper has an embossment height of greater than 800 μm, an embossment area of greater than 7.5 mm² and an embossment impression angle of less than 150°.

### Example 3

In another embodiment of the embossed paper products, two separate paper plies are made from the paper making process of Example 1. The two plies are then combined and embossed together by the knob-to-rubber impression embossing process of Example 1. The resulting paper has an embossment height of greater than 800 μm, an embossment area of greater than 7.5 mm² and an embossment impression angle of less than 150°.

### Example 4

In another embodiment of the embossed paper products, two separate paper plies are made from the paper making process of Example 1. One of the two plies is then embossed by the knob-to-rubber impression embossing process of Example 1. The resulting embossed ply from Example 1 is then combined with the second unembossed ply to create a two ply product of the present invention.

### Example 5

In another embodiment, three separate paper plies from the paper making process of Example 1 are produced. Two of the plies are embossed by the impression embossing process of Example 1 having the emboss characteristics of the ply of Example 1. The two embossed plies are then combined with the unembossed ply such that the unembossed ply is between the two embossed plies to create a three ply web material.

### Example 6

In another embodiment of the present invention the ply from the paper making process of Example 1 is subjected to a knob-to-rubber impression embossing process as follows. An emboss roll is engraved with a nonrandom pattern of protrusions. The emboss roll is mounted, along with a backside impression roll, in an apparatus with their respective axes being generally parallel to one another. The emboss roll comprises embossing protrusions which are frustaconical in shape, with a face (top or distal—i.e. away from the roll from which they protrude) diameter of about 2.79 mm and a floor (bottom or proximal—i.e. closest to the surface of the roll from which they protrude) diameter of about 4.12 mm. The height of the embossing protrusions on the emboss roll is about 2.845 mm. The radius of curvature of the transition region of the embossing protrusions is about 0.76 mm. The planar projected area of each embossing pattern single pattern unit is about 25 cm². The nonrandom pattern of emboss protrusions comprises approximately 10% emboss contact area. The backside impression roll is made of Valcoat™ material from Valley Roller Company, Mansfield, Tex. and has a P&J softness value of 125. The impression roll is set to deliver a nip length of about 2.125 inches (5.4 cm) by applying a pressure of approximately 150 pounds per linear inch (pli) of roller. The 150 pli applied to a 2.125 inch nip width on an emboss pattern with 10% contact area results in a pressure at the emboss knobs of from about 600 pounds per square inch to about 800 pounds per square inch of emboss contact area. The paper web is passed through the nip at a speed of 1000 feet per minute.

The resulting paper has an embossment height of greater than 800 μm, an embossment area of greater than 7.5 mm² and an embossment impression angle of less than 150°.

### Example 7

In another embodiment of the present invention the ply from the paper making process of Example 1 is subjected to a knob-to-rubber impression embossing process as follows. An emboss roll is engraved with a nonrandom pattern of protrusions. The emboss roll is mounted, along with a backside impression roll, in an apparatus with their respective axes being generally parallel to one another. The emboss roll comprises embossing protrusions which are frustaconical in shape, with a face (top or distal—i.e. away from the roll from which they protrude) diameter of about 2.79 mm and a floor (bottom or proximal—i.e. closest to the surface of the roll from which they protrude) diameter of about 4.12 mm. The height of the embossing protrusions on the emboss roll is about 2.845 mm. The radius of curvature of the transition region of the embossing protrusions is about 0.76 mm. The planar projected area of each embossing pattern single pattern unit is about 25 cm². The nonrandom pattern of emboss protrusions comprises approximately 10% emboss contact area. The backside impression roll is made of Plastoloy™ material from Stowe Woodward, Westborough, Mass. and has a P&J softness value of 160. The impression roll is set to deliver a nip length of about 1.75 inch (4.45 cm). The paper web is passed through the nip at a speed of 400 feet per minute.

The resulting paper has an embossment height of greater than 800 μm, an embossment area of greater than 7.5 mm² and an embossment impression angle of less than 150°.

### Example 8

One embodiment of a through-air dried, differential density structure, as described in U.S. Pat. No. 4,528,239 may be formed by the following process. The TAD carrier fabric of Example 1 is replaced with a carrier fabric consisting of 88.6 bi-axially staggered deflection conduits per cm, and a resin height of about 0.305 mm. The paper is subjected to the embossing process of Example 1. The resulting paper has an embossment height of greater than 800 μm, an embossment area of greater than 7.5 mm² and an embossment impression angle of less than 150°.

### Example 9

An alternative embodiment is a paper structure having single ply having a wet microcontraction greater than about 5% in combination with any known through air dried process. Wet microcontraction is described in U.S. Pat. No. 4,440,597. An example of wet microcontraction may be produced by the following process.

The wire speed is increased to about 706 meters per minute. The carrier fabric speed is about 635 meters per minute. The wire speed is 10% faster compared to the TAD carrier fabric so that the wet web foreshortening is 10%. The TAD carrier fabric of Example 1 is replaced by a carrier fabric having a 5-shed weave, 14.2 machine direction filaments and 12.6 cross-direction filaments per cm. The Yankee speed is about 635 meters per minute and the reel speed is about 572 meters per minute. The web is foreshortened 10% by wet microcontraction and an additional 10% by dry crepe. The resulting paper prior to embossing has a basis weight of about 33 gsm. The paper is subjected to the embossing process of Example 1. The resulting paper has an embossment height of greater than 800 μm, an embossment area of greater than 7.5 mm² and an embossment impression angle of less than 150°.

### Test Methods

The following describe the test methods utilized by the instant application in order to determine the values consistent with those presented herein.

Embossment Structure Measurement Method

The geometric characteristics of the embossment structure of the present invention are measured using an Optical 3D Measuring System MikroCAD compact for paper measurement instrument (the “GFM MikroCAD optical profiler instrument”) and ODSCAD Version 4.14 software available from GFMesstechnik GmbH, Warthestraβe E21, D14513 Teltow, Berlin, Germany. The GFM MikroCAD optical profiler instrument includes a compact optical measuring sensor based on digital micro-mirror projection, consisting of the following components:
A) A DMD projector with 1024×768 direct digital controlled micro-mirrors.
B) CCD camera with high resolution (1280×1024 pixels).
C) Projection optics adapted to a measuring area of at least 160×120mm.
D) Recording optics adapted to a measuring area of at least 160×120mm;
E) Schott KL1500 LCD cold light source.
F) A table stand consisting of a motorized telescoping mounting pillar and a hard stone plate;
G) Measuring, control and evaluation computer.
H) Measuring, control and evaluation software ODSCAD 4.14.
I) Adjusting probes for lateral (XY) and vertical (Z) calibration.

The GFM MikroCAD optical profiler system measures the height of a sample using the digital micro-mirror pattern projection technique. The result of the analysis is a map of surface height (Z) versus XY displacement. The system should provide a field of view of 160×120 mm with an XY resolution of 21 μm. The height resolution is set to between 0.10 μm and 1.00 μm. The height range is 64,000 times the resolution. To measure a fibrous structure sample, the following steps are utilized:
1. Turn on the cold-light source. The settings on the cold-light source are set to provide a reading of at least 2,800 k on the display.
2. Turn on the computer, monitor, and printer, and open the software.
3. Verify calibration accuracy by following the manufacturer's instructions.
4. Select “Start Measurement” icon from the ODSCAD task bar and then click the “Live Image” button.
5. Obtain a fibrous structure sample that is larger than the equipment field of view and conditioned at a temperature of 73° F. 2° F. (about 23° C.±1° C.) and a relative humidity of 50% ± 2% for 2 hours. Place the sample under the projection head. Position the projection head to be normal to the sample surface.
6. Adjust the distance between the sample and the projection head for best focus in the following manner. Turn on the “Show Cross” button. A blue cross should appear on the screen. Click the “Pattern” button repeatedly to project one of the several focusing patterns to aid in achieving the best focus. Select a pattern with a cross hair such as the one with the square. Adjust the focus control until the cross hair is aligned with the blue “cross” on the screen.
7. Adjust image brightness by increasing or decreasing the intensity of the cold light source or by altering the camera gains setting on the screen. When the illumination is optimum, the red circle at the bottom of the screen labeled “I.O.” will turn green.
8. Select “Standard” measurement type.
9. Click on the “Measure” button. The sample should remain stationary during the data acquisition.
10. To move the data into the analysis portion of the software, click on the clipboard/man icon.
11. Click on the icon “Draw Cutting Lines.” On the captured image, “draw” a cutting line that extends from the center of a negative embossment through the centers of at least six negative embossments, ending on the center of a final negative embossment. Click on the icon “Show Sectional Line Diagram.” Move the cross-hairs to a representative low point on one of the left hand negative embossments and click the mouse. Then move the cross-hairs to a representative low point on one of the right hand negative embossments and click the mouse. Click on the “Align” button by marked point's icon. The Sectional Line Diagram is now adjusted to the zero reference line.
12. Measurement of Emboss Height, h. Using the Sectional Line Diagram described in step 11, click the mouse on a representative low point of a negative emboss, followed by clicking the mouse on a representative point on the nearby upper surface of the sample. Click the “Vertical” distance icon. Record the distance measurement. Repeat the previous steps until the depth of six negative embossments have been measured. Take the average of all recorded numbers and report in mm, or μm, as desired. This number is the embossment height.
13. Measurement of Wall Angle, α. Using the Sectional Line Diagram of step 11, select with the mouse two points on the wall of a negative embossment that represent respectively 33% and 66% of the depth measured in step 12. Click the “Angle” icon. The ODSCAD software calculates the angle between a) the straight line connecting the two selected points and b) the zero reference line described in step 11. This angle is the wall angle. Repeat these steps for the six negative embossments measured in step 12.
14. Measurement of Emboss Area, A. Using the Sectional Line Diagram of step 11, select with the mouse two points on each wall of a negative embossment that represents 50% of the depth measured in step 12. Click the “horizontal distance” icon. The horizontal distance is the diameter of an equivalent circle. The area of that circle is calculated using the formula Area=2*pi*(d/2)ˆ2 and is recorded as the Equivalent Emboss Area. If the embossment shape is elliptical or irregular, more sectional lines are needed, cutting through the embossment from different directions, to calculate the equivalent area. Repeat these steps for the six negative embossments measured in step 12.

15. One example of these measurements is represented in FIG. 5.

Comparative Data

Samples of a variety of prior art embossed paper products and inventive products were tested for embossment height, embossment area, and emboss impression wall angle according to the test method described above.

TABLE 1
Tabulated Data for Various Known and Inventive Tissue Products

| | | Embossment | Embossment |
|---|---|---|---|
| | Embossment | Area | Impression |
| Product | Height (μ) | (mm²) | Angle (°) |
| Bounty | 621 | 7.477 | 150 |
| Brawny | 409 | 2.144 | 148 |
| Scott Super | 419 | 4.722 | 159 |
| White Swan | 562 | 2.561 | 151 |
| Albertsons | 766 | 3.235 | 144 |
| Kirkland | 599 | 3.335 | 153 |
| MM | 502 | 3.347 | 152 |
| Shop Value | 663 | 3.587 | 143 |
| MM | 489 | 3.812 | 148 |
| Kroger | 585 | 1.883 | 138 |
| Tedesco | 704 | 1.580 | 144 |
| Deep Nested Towel | 1118 | 11.553 | 152 |
| According to Published | | | |
| US Pat Serial No. | | | |
| 2005/0257910 A1 | | | |
| Inventive Product 1 | 1064 | 10.337 | 134 |
| Inventive Product 2 | 1134 | 11.105 | 135 |
| Inventive Product 3 | 1125 | 11.553 | 137 |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The dimensions and/or values disclosed herein are not to be understood as being strictly limited to the exact dimension and/or numerical value recited. Instead, unless otherwise specified, each such dimension and/or numerical value is intended to mean both the recited dimension and/or numerical value and a functionally equivalent range surrounding that dimension and/or numerical value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An embossed paper product comprising one or more plies of paper where at least one ply comprises a plurality of embossments where the embossments have an embossment height of from about 800 microns to about 2500 microns and an emboss impression angle of from about 90 degrees to about 150 degrees.

2. The embossed paper product according to claim 1 wherein the embossments have an emboss impression angle of from about 100 degrees to about 140 degrees.

3. The embossed paper product according to claim 2 wherein the embossments have an emboss impression angle of from about 110 to about 130 degrees.

4. The embossed paper product according to claim 1 wherein the embossments further comprise an emboss area from about 7.5 mm² to about 15 mm².

5. The embossed paper product according to claim 1 wherein the embossments have an embossment height of from about 1000 microns to about 2000 microns.

6. The embossed paper product according to claim 5 wherein the embossments have an embossment height of from about 1250 micron to about 1750 microns.

7. The embossed paper product according to claim 1 wherein the product comprises one embossed ply and one or more unembossed plies.

8. The embossed paper product according to claim 1 wherein the product comprises two embossed plies.

9. The embossed paper product according to claim 1 wherein the one or more plies of paper comprise through-air dried tissue paper.

10. The embossed paper product according to claim 1 comprising two plies bonded together with an adhesive.
